(19) United States
(12) Patent Application Publication
(10) Pub. No.: US 2007/0079114 A1
(43) Pub. Date: Apr. 5, 2007

(54) Method and system for the communication of a message as well as a suitable key generator for this

(76) Inventor: Henning Seemann, Aachen (DE)

Correspondence Address: NEIFELD IP LAW, PC, 4813-B EISENHOWER AVENUE, ALEXANDRIA, VA, 22304, US

(21) Appl. No.: 11/242,918

(22) Filed: Oct. 5, 2005

(51) Int. Cl. H04L 9/00

(52) U.S. Cl. 713/153

(57) ABSTRACT

A method and system for the communication of a message and for the generation of an encryption key. When a message sender initially addresses a request to a directory service, the request forms the basis of the directory service's search for a recipient address in an encryption key directory provided that the key directory contains the recipient address. The method and system reads out a recipient encryption key that is assigned to the recipient address in the key directory and communicates the recipient encryption key to the sender. The sender, using the recipient key, then encrypts the message and communicates the message to the recipient address.

The invention relates to a method and/or system for the communication of a message according to the pre-amble of claims 1 and 13 as well as a suitable key generator, wherein a sender initially addresses a request to a directory service, said request forming the basis of the directory service's search for a recipient address in a key directory provided that the key directory contains the recipient address; reads out a recipient key that is assigned to the recipient address in the key directory; and communicates said recipient key to the sender, wherein the sender, using the recipient key, then encrypts the message and communicates said message to the recipient address.

Methods and systems of the aforementioned type are well-known. In recent years, safety issues relating to this type of communication have gained an increasing relevance due to the precipitous jump in the distribution of “electronic mail” (so-called “e-mail”). Particularly major companies, authorities and associations with a plurality of staff members, who are moreover spatially distributed, increasingly ensure the authenticity and integrity of the information communicated by using electronic signatures as well as the privacy of the information communicated by applying cryptographic methods. Herein, use is made of various proprietary methods and, in addition and in particular, of standardized methods which are either, like “S/MIME” (“Secure Multipurpose Internet Mail Extension”), based on the formation of hierarchical certificate trees in accordance with the X.509 standard for PKI (“Public Key Infrastructure”) which is administered by ITU (“International Telecommunication Union”, www.itu.int) or, like OpenPGP, ensure the identity of the owner of the certificate through a “web of trust” without any hierarchy.

In addition to distribution, the known methods and/or systems provide directory services from which, on the one hand, keys for internal recipient addresses can be retrieved from inhouse databases and, on the other hand, keys for external communication partners can be retrieved from additional international directories. Herein, S/MIME certificates are, in the most cases, provided via directory services according to LDAP (“Lightweight Directory Access Protocol”), because these can be retrieved from the usual e-mail front ends.

The known methods and/or systems do not provide any possibility of forcing the encryption of e-mail traffic because it cannot be expected (or can be expected only in exceptional cases) that keys for external recipient addresses are existing as a matter of principle. Since recipient addresses without a key are only able to process non-encrypted e-mails, the stop of any non-encrypted communication would, at the same time, also prevent any e-mail exchange with these recipients.

If non-encrypted communication is permitted in a LAN, the privacy of e-mails is, as a matter of principle, not ensured because, for technical reasons, a packet-switching network is always providing “publicity”: any non-encrypted e-mail—including, for example, a “management e-mail” with personal or strategic contents—can also be read by any user of the internet with only little technical effort.

Additional safety issues are brought up by non-encrypted corporate communication, when staff members, who are using mobile terminals, receive and send e-mails through so-called push services. In a generally known implementation of such a push service, a push server is incorporated in the LAN, more or less as an internal user, and imparts the e-mail communication with the mobile terminals to a plurality of the provider's node computers which are distributed in a worldwide network and to various mobile radio telephone service providers via its own internet connection.

Theoretically, such a push server in the LAN, owing to the structure of rights required for executing its task, might be able to access all e-mails distributed in the network and to transfer these e-mails via the node computers. Since the node computers are beyond the LAN operator's control, the latter is not able to ensure and verify from his point of view the safety and trustworthyness of said node computers. At least theoretically, this gives rise to the danger that information is imparted to non-authorized parties.

If, over and beyond this, unsigned communication is also permitted in the LAN, the authenticity and identity of any such e-mail must always be doubted, because e-mails with forged identity can be transmitted or captured and manipulated subsequently. As a matter of principle, it is not only not allowed to treat unsigned e-mails as a legally effective declaration of intention, but where unsigned communication is permitted, it is not possible either to prevent the willful distribution of false messages with the aim of descrediting (“mobbing”) other persons. Altogether, the approval of non-encrypted and/or unsigned communication, even in a corporate LAN, regularly increases both the technical and administrative expenditures as well as the requirements for defining behavioral rules in communication (and verifying the compliance therewith).

Object

The invention aims at facilitating the encryption of all messages in a LAN without restricting the selection of communication partners.

Solution

This problem is solved by the method comprising the elements of claim 1 and by the system or device comprising the elements of claims 13 or 16 respectively.

According to the application, it is proposed that, unless the key directory contains the recipient address, a key generator generates a gateway key on request and communicates said key to the sender, wherein the sender then encrypts the message by means of the gateway key and finally communicates said message to the recipient address via a mail gateway (11) which decrypts said message.

According to the application, the directory service or the key generator always communicates to the sender on the latter's request a key which is suitable for encrypting the message—that is either the recipient key or the gateway key. Thus, the encryption of a message that the mail server has communicated from senders in the LAN to any recipient address desired is independent of whether a recipient key assigned to the recipient address exists in an internal or external key directory. Nevertheless, communication with recipient addresses for which it was not possible to determine a recipient key on request is still enabled without any restrictions by the method according to the invention since, in this case, the sender encrypts using the gateway key: if a message encrypted with said gateway key and coming from the LAN arrives at the mail gateway, then said message is decrypted and transferred to the external recipient address in this decrypted from (that is in plaintext). In connection with the appropriate behavioral rules for e-mail communication or by means of technical measures prohibiting or excluding the non-encrypted transmission of messages in the LAN, the encryption of all messages communicated by senders in the LAN by means of the mail gateway can be ensured.

The method and/or system according to the application can also be used in comparable form with other message push services. Such services are characterized by communication according to the “store-and-forward” principle which does not provide the retrieval of a recipient key in the dialog with the recipient. In this case, the term “mail gateway” comprises gateways for such push services.

Advantageous further developments of the subjects according to the application are described in the elements of the subordinate claims. Within the scope of the method and/or system according to the application, the key generator preferrably generates a gateway key personalized to the recipient address. Such a method and/or system according to the application even allows the sender in the LAN to use widely spread e-mail front ends (such as Microsoft® Outlook®) which only permit the use of personalized certificates with a functionality that is restricted as compared with standards.

With particular preference, the gateway key is assigned to the recipient address in the key directory. After having been generated on the occasion of a first request, the gateway key will then be available for further requests from the LAN without any further calculation. On the one hand, such a method and/or system requires less calculation steps as compared with a method without storage of the gateway key (with memory requirements that are only irrelevantly increased in view of the prices for storage media). On the other hand, it must be ensured that a message encrypted with the gateway key at the sender's will still be decrypted by the mail gateway even if it arrives at the mail gateway some time later. Herein, the period of validity of a gateway key is, preferrably, limited to a few days, for example to one week. The gateway key can, in particular, be stored in a cache directly assigned to the key generator.

In an advantageous embodiment, the key generator, together with the gateway key, generates a decryption key assigned to said gateway key, and the mail gateway decrypts the message by means of the decryption key. That means that such a method and/or system uses an asymmetrical encryption method, where the sender encrypts a message with a public key (here: gateway key) and the recipient (here: mail gateway) decrypts the message with a secret and “private” key (here: decryption key) that is exclusively known to him. As compared with a symmetrical decryption method that can be used as an alternative and which uses the same key for encryption and decryption, the asymmetrical decryption is less vulnerable to the unintentional distribution of the key required for decryption.

With particular preference, the gateway key is part of a certificate. Owing to their widespread distribution and to the implementation in all relevant front ends, S/MIME certificates particularly enable the application of the method according to the invention, in most cases even without any additional programs.

Preferrably, the message is communicated by the sender to the recipient address via a mail server. Herein, the mail server may, in particular, be a part of the internal infrastructure of a LAN—as is usual with large-size company networks. The mail gateway will then usually be arranged between the mail server and the internet. As an alternative, the method according to the invention can also be used in a LAN without its own mail server, provided that the various staff members who are users in the LAN receive their e-mail messages from an external SMTP server.

Preferrably, existing mail gateways can use a key generator to sign outgoing e-mails with a key that has not been available hitherto. Further advantageous embodiments are subject of the further claims.

Exemplary embodiment

The subject according to the application will be illustrated below by means of an exemplary embodiment. The figures of the drawing are schematic views of various aspects of the execution of the method and/or system according to the application. In the Figures:

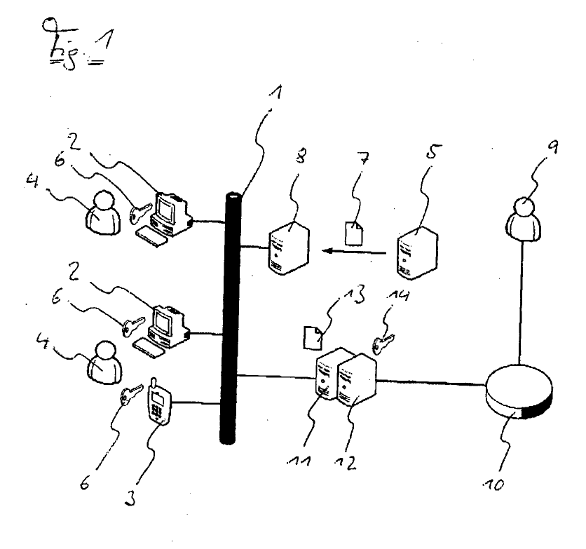

FIG. 1 is a view of the handling of the system;

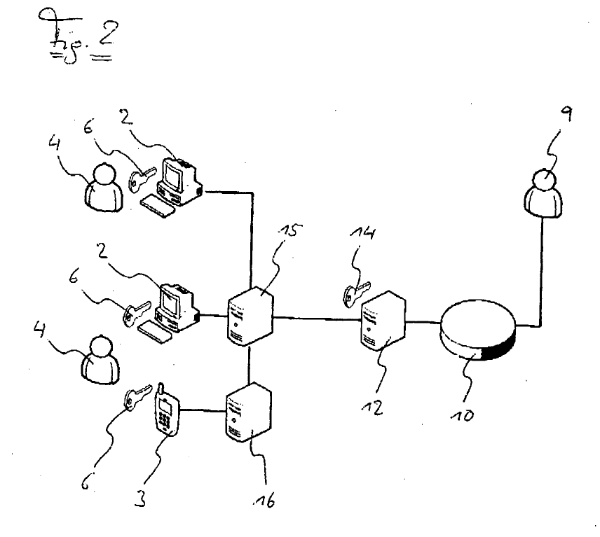

FIG. 2 is a view of the incorporation of a push server; and

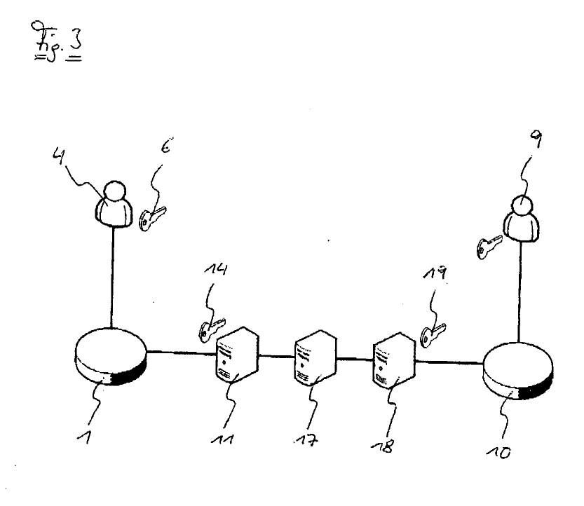

FIG. 3 is a view of the incorporation of a virus and spam protection system.

According to FIG. 1, a cabled corporate LAN 1 comprises display work stations 2 and mobile terminals 3 of staff members 4 that are networked with each other. An internal certification station 5 provides the staff members 4 with personalized keys 6 for signing e-mails, for example on a hardware token (not shown). The public recipient keys 7 for encrypting e-mails sent to the staff members 4 are published by the internal certification station 5 together with the related meta-information of the staff members 4 in an inhouse key directory 8.

The communication of the staff members 4 from the LAN to external partners 9 through the internet 10 is established via a mail gateway 11. Herein, the term “gateway”(which corresponds to the nomenclature of the OSI layer model according to ISO 7498-1 and DIN ISO 7498) illustrates that—in contrast to the exclusive transfer functionality of the mail server—both the form and the content of the data communicated is adjusted to the requirements of the particular recipient. In the case presented here, the mail gateway 11 ensures (in cooperation with further components described subsequently) that the e-mail messages distributed in the LAN 1 are always signed and encrypted, irrespective of whether they are transferred to partners 9 in encrypted form or whether they are received by said partners 9 in signed or encrypted form.

If a staff member intends to send an e-mail to an external partner 9, he or she selects said partner's recipient address from his or her front end (not shown) in a first step. The front end automatically sends a request to a directory service which attempts to determine a recipient key 7 on the basis of the recipient address, first in the local key directory 8 and then in various external key directories (not shown), in order to encrypt the e-mail. If the request is successful, the recipient key 7 determined is transferred to the front end. If the request is only successful in one of the external directories, the recipient key 7 determined will be temporarily stored in the local key directory 8 for later use.

If the request is neither successful in the local key directory 8 nor in the external key directories, the request will be transferred to a key generator 12 which is connected to the mail gateway 11, said key generator 12 generating a public gateway key 13 for the recipient address and sending said gateway key 13 to the front end. At the same time, the key generator 12 generates a “private” decryption key 14 and transfers it to the mail gateway 11. The front end encrypts the e-mail using the gateway key 13 and sends it to the mail gateway 11. The mail gateway 11 decrypts the e-mail by means of the decryption key 14 and transfers it in decrypted form to the external partner 9 through the internet 10.

Within the LAN 1, including the internal mail server 15 and a push server 16 connected thereto according to FIG. 2, the use of the mail gateway 11 allows to sign and encrypt the entire e-mail communication. FIG. 3 shows the incorporation of a spam and virus scanner 17 in the gateway architecture. Said scanner 17 is arranged between the internal mail gateway 11 and a second external mail gateway 18. The external mail gate-way 18 has access to a further personal key 19 of the staff members 4 (in a manner not shown here). (The keys 6 and 19 of the staff members 4 may be identical.) Using these keys 19, the external mail gateway 18 decrypts any external e-mail communication directed to the staff members 4 in encrypted form and transfers said e-mail communication to the spam and virus scanner 17. If the latter objects to the incoming e-mail, the recipient is automatically informed and, in addition, instructed on how to proceed further. If it is not objected to, the e-mail is provided with an appropriate note and transferred to the internal mail gateway 11 which encrypts said e-mail with the public key of the recipient and signs it, for example, with the decryption key 14 of the internal mail gateway 11.

In the manner described, any e-mail that is incoming from the internet 10 in unsigned or non-encrypted form is provided with an appropriate note and subsequently encrypted with the recipient's public key and signed, for example, with the decryption key 14 of the internal mail gateway 11. In addition, the mail server 15 is configured such that non-encrypted or unsigned e-mails are, as a matter of principle, not transferred to the recipient but are returned to the sender with a failure notice. Hence, in combination with the functionality of the internal mail gateway 11 described, in particular in combination with the key generator 12, it is ensured that any e-mail communication distributed over the LAN 1—including the communication via the push server—is both signed and encrypted.

The reference numbers in the figures of the drawing are assigned as follows:
1 LAN
2 Display work station
3 Mobile terminal
4 Staff member
5 Internal certification station
6 Personalized key
7 Recipient key
8 Key directory
9 External partner
10 Internet
11 Mail gateway (internal)
12 Key generator
13 Gateway key
14 “Private” decryption key
15 Mail server
16 Push server
17 Spam and virus scanner
18 External mail gateway
19 Personal key

1. A method for the communication of a message, wherein a sender initially addresses a request to a directory service, said request forming the basis of the directory service's search for a recipient address in a key directory (8) provided that said key directory (8) contains the recipient address; reads out a recipient key (7) that is assigned to the recipient address in the key directory (8); and communicates said recipient (7) key to the sender, wherein the sender then encrypts the message by means of the recipient key (7) and communicates said message to the recipient address, characterized in that, unless the key directory (8) contains the recipient address, a key generator (12) generates a gateway key (13) on request and communicates said gateway key (13) to the sender, wherein the sender then encrypts the message by means of said gateway key (13) and finally communicates said message to the recipient address via a mail gateway (11) which decrypts said message.

2. A method according to the preceding claim, characterized in that the key generator (12) generates a gateway key (13) personalized to the recipient address.

3. A method according to anyone of the preceding claims, characterized in that the gateway key (13) is assigned to the recipient address in the key directory (8).

4. A method according to anyone of the preceding claims, characterized in that the key generator (12), together with the gateway key (13), generates a decryption key (14) assigned to said gateway key (13), and the mail gateway (11) decrypts the message by means of the decryption key (14).

5. A method according to the preceding claim, characterized in that the gateway key (13) is part of a certificate.

6. A method according to anyone of the preceding claims, characterized in that the message is communicated by the sender to the recipient address via a mail server.

7. A system for the communication of a message, in particular for applying the method according to anyone of claims 1 to 7, comprising a means for a directory service receiving a request from a sender, wherein said means for said directory service searches a recipient address in a means for a key directory (8), characterized by a key generator which is provided to generate a gateway key based on the request, if the key directory fails to contain the recipient address.

8. A system according to claim 7, characterized in that a means for encrypting the message is provided by means of the gateway key.

9. A system according to claim 7 or 8, characterized in that a means for signing the message is provided by means of the gateway key.

10. A system according to anyone of claims 7 to 9, characterized in that a mail gateway is provided for signing.

11. A system according to anyone of claims 7 to 10, characterized in that a mail gateway is provided for decrypting the message.

12. A system according to anyone of claims 7 to 11, characterized in that the key generator (12) has generated a gateway key (13) personalized to the recipient address.

13. A system according to anyone of claims 7 to 12, characterized in that the gateway key (13) is assigned to the recipient address in the key directory.

14. A system according to anyone of claims 7 to 13, characterized in that the key generator (12), together with the gateway key (13), generates a decryption key (14) assigned to said gateway key (13), and the mail gateway (11) decrypts the message by means of said decryption key (14).

15. A system according to anyone of claims 7 to 14, characterized in that the gateway key (13) is part of a certificate.

16. A key generator, in particular for use with the method according to anyone of claims 1 to 6, or for use with the system according to anyone of claims 7 to 15, said key generator generating a gateway key based on a request from a sender to a directory service.

17. A key generator according to claim 16, characterized in that the gateway key is generated if a key directory fails to contain the recipient address requested by the sender.
